(19) United States
(12) Patent Application Publication
(10) Pub. No.: US 2023/0297850 A1
(43) Pub. Date: Sep. 21, 2023

(54) GENERATING CONTEXTUAL ADVISORY FOR XaaS BY CAPTURING USER-INCLINATION AND NAVIGATING USER THROUGH COMPLEX INTERDEPENDENT DECISIONS

(71) Applicant: Tata Consultancy Services Limited, Mumbai (IN)

(72) Inventors: Spandan MAHAPATRA, Atlanta, GA (US); Gajanan Haribhau KAMBLE, Pune (IN); Akshay CHAUDHARY, Lucknow (IN); Bala Prasad PEDDIGARI, Hyderabad (IN); Kanishk Bharatkumar CHAUHAN, Pune (IN)

(73) Assignee: Tata Consultancy Services Limited, Mumbai (IN)

(21) Appl. No.: 18/122,345

(22) Filed: Mar. 16, 2023

(30) Foreign Application Priority Data
Mar. 21, 2022 (IN) 202221015542

(51) Int. Cl. G06N 5/02; G06N 5/046

(52) U.S. Cl. CPC G06N 5/02; G06N 5/046

(57) ABSTRACT

State of art techniques hardly provide technical solution to address complex dependencies that exist between different areas of SaaSification. Embodiments of the present disclosure provide a method and system for a contextual advisory for a platform, a process, a technology, and technical components to build Everything as a service (XaaS) for a domain of interest. The method dynamically generates contextual advisory and recommendations to build the XaaS on users input from assessment and decision navigation. Decision navigation captures complex interdependencies of business, design, technology etc. User inclination/inferences are captured from assessment. In accordance with initial inclination of the user, the user is navigated through decision making process involved in building the XaaS model for the domain of interest of the user. The system recommends the decision and generates the dynamic information based on user inputs which is used to generate the advisory documents.

### PRIORITY CLAIM

This U.S. patent application claims priority under 35 U.S.C. § 119 to: Indian Patent Application No. 202221015542, filed on 21 Mar. 2022. The entire contents of the aforementioned application are incorporated herein by reference.

### TECHNICAL FIELD

The embodiments herein generally relate to cloud computing and, more particularly, to a method and system for generating contextual advisory for Everything as a service (XaaS) by capturing user-inclination and navigating user through complex interdependent decisions.

### BACKGROUND

Enterprises are moving towards offering Everything as a Service (XaaS), also referred to as Anything as a Service, through platform driven solutions. Their product strategy is either to re-architecting their products for Software as a Service (SaaS) or building SaaS products from scratch. Embarking on this journey with the available documentation and trials is an expensive, time-consuming, and burdensome process. Thus, enterprises struggle to re-architect their products into SaaS. They make trial and experiments to achieve the target architecture. This conventional approach is expensive and time consuming and does not help the enterprises to realize their business objectives.

SaaS products have complex cloud native technology ecosystem. These technologies are user interface technologies (Web, mobility, APIs, CLIs, Libraries, SDKs etc.), authentication and authorization systems, integration system, containerization, cloud native features, cloud engineering environment, backend IT Systems, metering, usage, billing, invoicing, payment, and subscription management systems, and communication models. Business related aspects of SaaSification include subscription models, pricing, customer value, revenue recognition, market and competitive positioning, customer satisfaction and retention, partnerships, and collaborations etc. Design areas include complex choices of multi-tenancy, security, reliability, onboarding, and setup etc. Current methods of decision making for XaaS or SaaSification are isolated in terms that they provide solution to individual or for very limited set of areas. Also, it is technically challenging for existing methods to consider impact of one solution choice in one area over the solution in other areas and further challenging to provide unified view of entire SaaS ecosystem which spans across technology, business, and design areas.

### SUMMARY

Embodiments of the present disclosure present technological improvements as solutions to one or more of the above-mentioned technical problems recognized by the inventors in conventional systems.

For example, in one embodiment, a method for a contextual advisory for Everything as a service (XaaS) is provided. The method includes obtaining a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions, wherein (a) each successive question among the set of questions is identified based on the response of the user to a previous question and is mapped to an initial inference node among a plurality of inference nodes preset in an inference table, (b) wherein each inference node corresponds to a set of inferences with each inference among the set of inferences having an initial inference weightage, (c) wherein the initial inference node and the initial inference weightage of each inference node is iteratively updated in accordance with the response of the user to each question, and (d) wherein each inference node among the set of interference nodes is mapped to a decision node from among a plurality of decision nodes. Further, the method includes identifying a final inference node and a corresponding decision node among the plurality of decision nodes as an initial decision node, post querying the user with the set of questions, wherein the final interference node indicates initial user inclination and a current architecture of the user in the domain of interest. Further, the method includes generating in the form of knowledge graph (a) a global knowledge repository for the domain of interest based on artifacts provided by a Subject Matter Expert (SME), and (b) a local knowledge repository for the current architecture based on artifacts provided by the user. Further, the method includes generating a feature matrix, by extracting one or more entities from the global knowledge repository in accordance with a plurality of inputs, provided by the SME, and comprising a list of properties, a weightage of each of the list of properties and a list of components for the domain of interest. Furthermore, the method includes sequentially querying with a set of decision questions starting with context of the initial decision node and receiving a corresponding decision response for each decision question among the set of decision questions. Each decision question has an associated decision response type, one or more choices for a decision response, dependency links of a decision question with remaining decision questions among the set of decision questions, a decision question weightage and information in an attribute value form associated with each decision response. Each successive decision question among the set of decision questions is identified based on the decision response of the user to a previous decision question. Further, the method includes generating a decision graph tracing a plurality of decision nodes starting from the initial decision node based on each decision response for each of the decision questions. Furthermore, the method includes utilizing a decision path identified from the decision graph and the information in the attribute value form associated with each decision response for providing the contextual advisory to build XaaS for the domain of interest using document templates.

In another aspect, a system for contextual advisory for Everything as a service (XaaS) is provided. The system comprises a memory storing instructions; one or more Input/Output (I/O) interfaces; and one or more hardware processors coupled to the memory via the one or more I/O interfaces, wherein the one or more hardware processors are configured by the instructions to obtain a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions, wherein (a) each successive question among the set of questions is identified based on the response of the user to a previous question and is mapped to an initial inference node among a plurality of inference nodes preset in an inference table, (b) wherein each inference node corresponds to a set of inferences with each inference among the set of inferences having an initial inference weightage, (c) wherein the initial inference node and the initial inference weightage of each inference node is iteratively updated in accordance with the response of the user to each question, and (d) wherein each inference node among the set of interference nodes is mapped to a decision node from among a plurality of decision nodes. Further, the one or more hardware processors are configured to identify a final inference node and a corresponding decision node among the plurality of decision nodes as an initial decision node, post querying the user with the set of questions, wherein the final interference node indicates initial user inclination and a current architecture of the user in the domain of interest. Further, the one or more hardware processors are configured to generate in the form of knowledge graph (a) a global knowledge repository for the domain of interest based on artifacts provided by a Subject Matter Expert (SME), and (b) a local knowledge repository for the current architecture based on artifacts provided by the user. Further, the one or more hardware processors are configured to generate a feature matrix, by extracting one or more entities from the global knowledge repository in accordance with a plurality of inputs, provided by the SME, and comprising a list of properties, a weightage of each of the list of properties and a list of components for the domain of interest. Furthermore, the one or more hardware processors are configured to sequentially query the user with a set of decision questions starting with context of the initial decision node and receiving a corresponding decision response for each decision question among the set of decision questions. Each decision question has an associated decision response type, one or more choices for a decision response, dependency links of a decision question with remaining decision questions among the set of decision questions, a decision question weightage and information in an attribute value form associated with each decision response. Each successive decision question among the set of decision questions is identified based on the decision response of the user to a previous decision question. Further, the one or more hardware processors are configured to generate a decision graph tracing a plurality of decision nodes starting from the initial decision node based on each decision response for each of the decision questions. Furthermore, the one or more hardware processors are configured to utilize a decision path identified from the decision graph and the information in the attribute value form associated with each decision response for providing the contextual advisory to build XaaS for the domain of interest using document templates.

In yet another aspect, there are provided one or more non-transitory machine-readable information storage mediums comprising one or more instructions, which when executed by one or more hardware processors causes a method for contextual advisory for Everything as a service (XaaS).

The method includes obtaining a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions, wherein (a) each successive question among the set of questions is identified based on the response of the user to a previous question and is mapped to an initial inference node among a plurality of inference nodes preset in an inference table, (b) wherein each inference node corresponds to a set of inferences with each inference among the set of inferences having an initial inference weightage, (c) wherein the initial inference node and the initial inference weightage of each inference node is iteratively updated in accordance with the response of the user to each question, and (d) wherein each inference node among the set of interference nodes is mapped to a decision node from among a plurality of decision nodes. Further, the method includes identifying a final inference node and a corresponding decision node among the plurality of decision nodes as an initial decision node, post querying the user with the set of questions, wherein the final interference node indicates initial user inclination and a current architecture of the user in the domain of interest. Further, the method includes generating in the form of knowledge graph (a) a global knowledge repository for the domain of interest based on artifacts provided by a Subject Matter Expert (SME), and (b) a local knowledge repository for the current architecture based on artifacts provided by the user. Further, the method includes generating a feature matrix, by extracting one or more entities from the global knowledge repository in accordance with a plurality of inputs, provided by the SME, and comprising a list of properties, a weightage of each of the list of properties and a list of components for the domain of interest. Furthermore, the method includes sequentially querying with a set of decision questions starting with context of the initial decision node and receiving a corresponding decision response for each decision question among the set of decision questions. Each decision question has an associated decision response type, one or more choices for a decision response, dependency links of a decision question with remaining decision questions among the set of decision questions, a decision question weightage and information in an attribute value form associated with each decision response. Each successive decision question among the set of decision questions is identified based on the decision response of the user to a previous decision question. Further, the method includes generating a decision graph tracing a plurality of decision nodes starting from the initial decision node based on each decision response for each of the decision questions. Furthermore, the method includes utilizing a decision path identified from the decision graph and the information in the attribute value form associated with each decision response for providing the contextual advisory to build XaaS for the domain of interest using document templates.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system, for contextual advisory for Everything as a service (XaaS), in accordance with some embodiments of the present disclosure.

FIG. 1B illustrates an architectural overview of the system of FIG. 1A, in accordance with some embodiments of the present disclosure.

FIG. 1C illustrates a process overview of the system of FIG. 1B, in accordance with some embodiments of the present disclosure.

FIG. 2A-2B (collectively referred as FIG. 2) is a flow diagram illustrating a method for contextual advisory for Everything as a service (XaaS), using the system of FIG. 1, in accordance with some embodiments of the present disclosure.

FIG. 3 is an example global and local knowledge graph generated by the system of FIG. 1B in accordance with some embodiments of the present disclosure.

FIG. 4A is an example feature matrix in tabular form generated by the system of FIG. 1B, in accordance with some embodiments of the present disclosure.

FIG. 4B is another example of feature matrix in graph database corresponding to example FIG. 4A, in accordance with some embodiments of the present disclosure.

FIG. 5 is another example feature matrix in tabular form and associated dynamically generated question based on the feature matrix, in accordance with some embodiments of the present disclosure.

FIG. 6A depicts decision logic flow of a decision module of the system of FIG. 1 for a use case scenario and FIG. 6B depicts the entire workflow of the system for the use case scenario, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

A set of attributes involved in moving toward ‘as a service’ model is listed below. Each area attribute further has various sub items which play an important role in determining development approach to move towards Everything as a Service (XaaS or XaaS). Selection of these attribute choices and understanding dependencies is complex.

Business
Subscription and pricing models
Revenue recognition
Customer satisfaction and retention
Customer engagement
Partnerships and collaborations
Market and competitive positioning
Audit and regulatory compliance

Technology
User interface technologies (Web, mobility, APIs, CLIs, Libraries, SDKs etc.)
Authentication and authorization systems
Integration systems
Subscription, entitlement, billing, metering, usage, invoicing, payment, and audit trails
Engineering, delivery, and deployment systems Backend IT Systems
Operating environments

Design/Architecture, Multi-Tenancy
Containerization
Customization and configuration
Security
Cloud native features
Reliability
Scalability
UX and Accessibility
Onboarding and setup
Disaster recovery. Standards conformance
Globalization

Furthermore, there is no dependency map created to consider impact of particular solution for one attribute on solution choice for another attribute. For example, if selection of multi-tenancy architecture has impact on cost factor in business area as well as impact on containerization and deployment technology choices. The dynamic nature and fast pace of technology advancement is also another reason that SaaSification area currently hardly has any comprehensive solution make quick decisions. Further, complex dependencies exist between different areas of SaaSification making SaaSification choices time consuming and cumbersome process.

Embodiments of the present disclosure provide a method and system for a contextual advisory for a platform, a process, a technology, and technical components to build Everything as a service (XaaS) for a domain of interest. The method dynamically generates contextual advisory and recommendations to build the XaaS on users input from assessment and decision navigation by using decision graphs to capture complex dependencies of business, technology, design etc., and navigate user through it. User inclination/inferences are captured from assessment and enable the system to understand the domain of interest and maturity of the user in the domain. In accordance with initial inclination of the user, the user is swiftly navigated by the system through decision making process for building the XaaS model for the domain of interest. Further, the system recommends the decision using Machine Learning (ML) based approaches and generates the dynamic information based on user inputs, which is used to generate the advisory documents. The contextual advisory provides speedy customized solution for XaaS including roadmaps, blueprint, reference architecture and miscellaneous advisory documents, wherein the contextual advisory is a combination of static document with marked dynamics sections populated based on a decision path the user is navigated through.

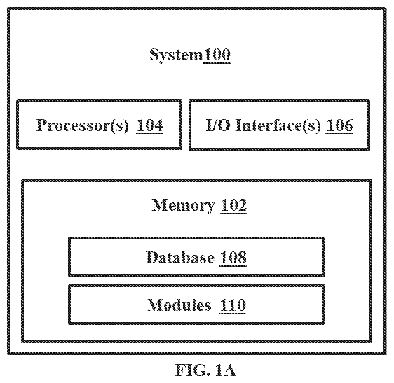

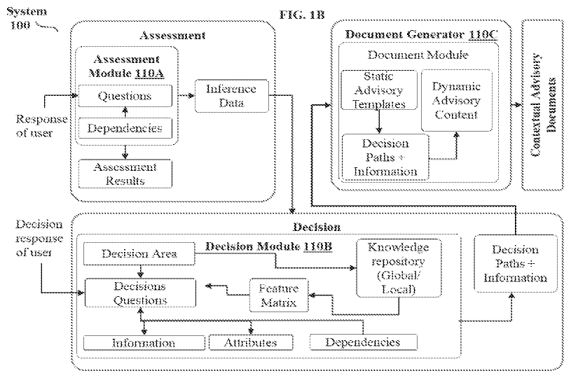

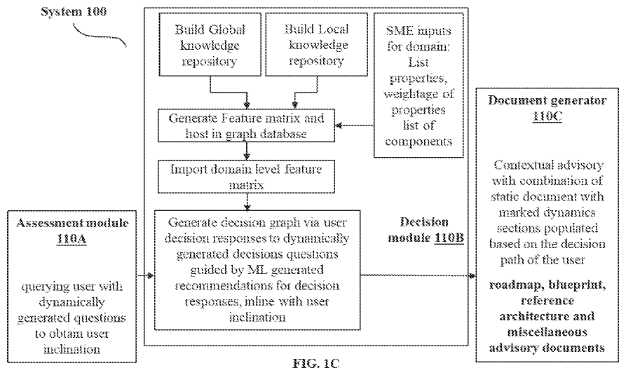

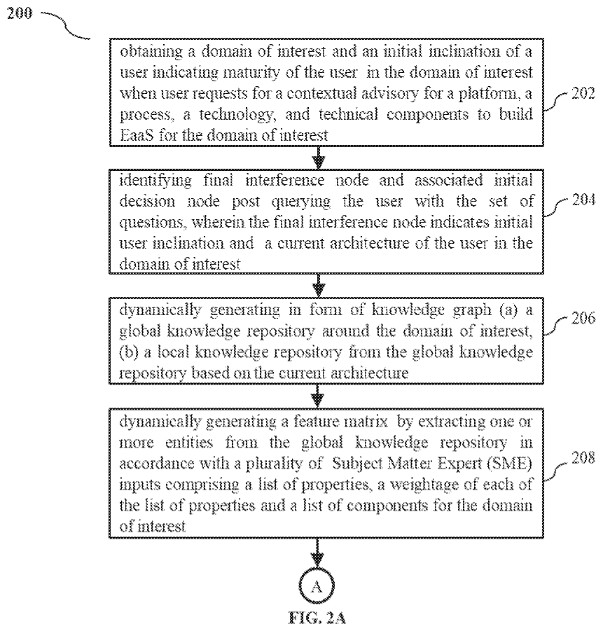

Referring now to the drawings, and more particularly to FIGS. 1A through 6B, where similar reference characters denote corresponding features consistently throughout the figures, there are shown preferred embodiments and these embodiments are described in the context of the following exemplary system and/or method.

FIG. 1A is a functional block diagram of a system 100, for contextual advisory for Everything as a service (XaaS), in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface to display the generated target images and the like and can facilitate multiple communications within a wide variety of networks N/W and protocol types, including wired networks, for example, LAN, cable, etc., and wireless networks, such as WLAN, cellular and the like. In an embodiment, the I/O interface (s) 106 can include one or more ports for connecting to a number of external devices or to another server or devices.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

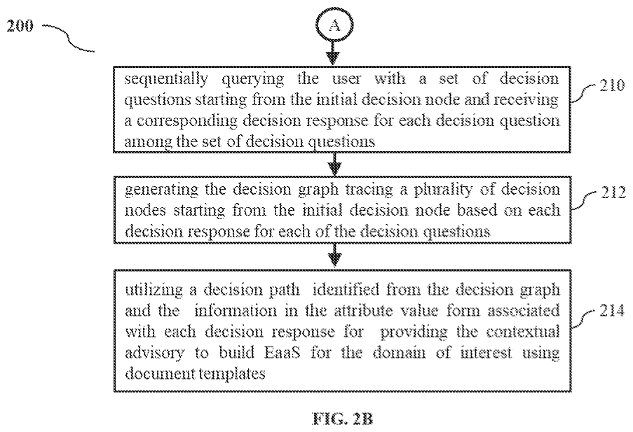

Further, the memory 102 includes a plurality of modules 110 comprising an assessment module 110A, a decision module 110B, a document generator 110C as depicted in an architectural overview of the system 100 along with ML models and other modules (not shown) to generate the contextual advisory documents for the domain of interest of the user. The ML models known in the art are pretrained using training data to server various intelligent automated decisions as explained later. Further, the memory 102 includes a database 108 that stores a local knowledge repository (local KR), a global knowledge repository (global KR), a plurality of inputs provided by a Subject Matter Expert (SME), feature matrix generated for domain of interest, a set of questions dynamically generated by the assessment module 110A and corresponding responses by the user, a set of decision questions dynamically generated by the decision module 110B and corresponding decision responses of the user, contextual advisory documents generated for the domain of interest in response to user request for a platform, a process, a technology, and technical components to build Everything as a service (XaaS) for the domain of interest and the like. Further, the memory 102 may comprise information pertaining to input(s)/output(s) of each step performed by the processor(s) 104 of the system 100 and methods of the present disclosure. In an embodiment, the database 108 may be external (not shown) to the system 100 and coupled to the system via the I/O interface 106. Functions of the components of the system 100 are explained in conjunction the architectural overview of the system 100 as depicted in FIG. 1B, a process overview of the system 100 as depicted in FIG. 1C and method of FIG. 2.

As depicted in FIG. 1B the system 100 dynamically generates contextual advisory or decisions for platform, process, technology, and technical components while building the XaaS model for a domain of interest. For the user requesting the contextual advisory service, initial assessment is performed using the assessment module 110A to determine current maturity level for the domain if interest, also referred as Focus Area of the assessment. Based on the initial assessment. User inclination is obtained, and the user is accordingly navigated to mature his/her initial requirements by providing them contextual and precise decisions by the decision module 110B to provide the contextual advisory by the document generator 110C for the domain of interest. As mentioned the contextual advisory provides customized solution to the user for XaaS including roadmaps, blueprint, reference architecture and miscellaneous advisory documents. The contextual advisory is a combination of static document with marked dynamics sections populated based on a decision path the user is navigated through.

FIG. 2 is a flow diagram illustrating a method 200 for contextual advisory for Everything as a service (XaaS), using the system of FIG. 1, in accordance with some embodiments of the present disclosure. In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIG. 1A, 1B and the steps of flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

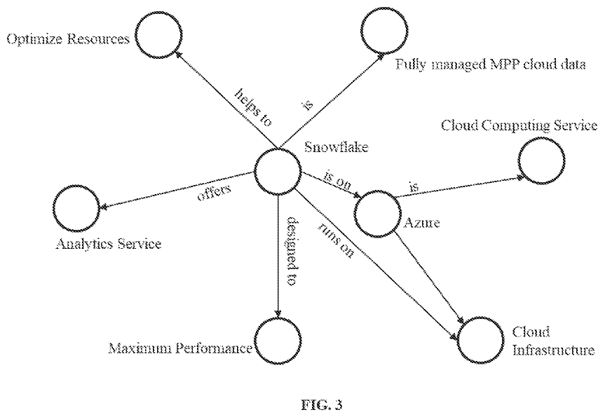

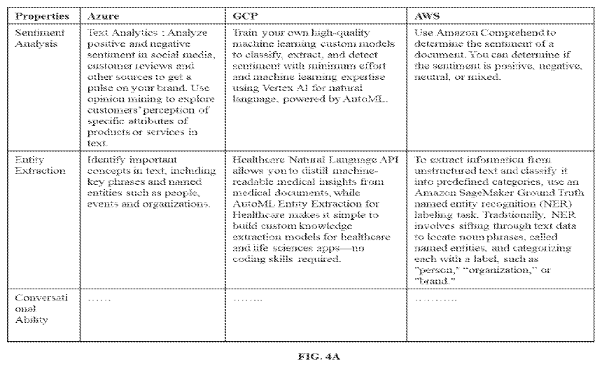

Referring to the steps of the method 200, at step 202 of the method 200, the one or more hardware processors 104 obtain a domain of interest and an initial inclination of a user indicating maturity of the user in the domain of interest when user requests for a contextual advisory for a platform, a process, a technology, and technical components to build Everything as a service (XaaS) for the domain of interest. The entire steps 202 through 214 of the method are explained in conjunction with a use case scenario and FIGS. 3 through 6B. The initial inclination is obtained by sequentially querying the user, by the assessment module 110A executed by the one or more hardware processors 104, with the set of questions. Further, a corresponding response for each question among the set of questions is received. Each successive question among the set of questions is identified based on the response of the user to a previous question and is mapped to an initial inference node among a plurality of inference nodes preset in an inference table. Each inference node corresponds to a set of inferences with each inference among the set of inferences having an initial inference weightage. The initial inference node and the initial inference weightage of each inference node is iteratively updated in accordance with the response of the user to each successive question. Each inference node among the set of interference nodes is mapped to a decision node from among a plurality of decision nodes. The assessment module 110A consists of questions, associated information, interdependencies among questions and inference table and is created with information on above nodes. Each question among the set of questions has an associated response type, one or more choices for a response, dependency links of a question with remaining questions among the set of questions, and a question weightage. For example, if the user answers that they are using Microsoft cloud or any inclination towards using Microsoft technology for cloud then Azure Environment is mapped into inference table. Inference table may also have Google cloud if Google technology is created.
a) Initial set of assessment questions are displayed to user along with answer choices; and prompting the user to answer depending on answer type.
b) Based on user's answer, next set of questions are selected by system using dependencies and weightages associated with it. This is done by identifying a first assessment node in an assessment graph corresponding to the question and determining next question to be displayed to the user based on a second assessment node linked to the first assessment node in the assessment graph. In case of multiple assessment nodes, higher weightage nodes take priority.
c) As user answer questions, inference information is modified using information set with question. Inferences table is modified with weightages. While creating the questions and answers, possible inferences and weightages are created. These inferences and weightage increments are modified as user answers the questions.
d) Answer information is saved with associated assessment question node.
e) User iterates through question and answers as system keep on generating them dynamically. Answer value is saved with each assessment node, inferences table is modified.

At step 204 of the method 200, once the user is queried with entire set of questions finalization of inferences is performed by sorting on weightages and pass it to the decision module 110B. Thus, at step 204, the one or more hardware processors 104 identify a final interference node and a corresponding decision node among the plurality of decision nodes as an initial decision node, post querying the user with entire set of questions, wherein the final interference node indicates initial user inclination and a current architecture of the user in the domain of interest. The assessment module 110A generates inference data which is passed to the decision module 110B executed by the one or more hardware processors 104 to contextualize decision making process. The decision module 110B sets the weightages of the decisions from inference table. Now decision module 110B is ready for further analysis as it has captured inclination of user dynamically based on interaction with user.

The decision module 110B is supported by the global knowledge repository and the local knowledge repositor, which is generated at step 206 of the method 200 in form of knowledge graph (a) a global knowledge repository for the domain of interest based on global artifacts provided by a SME, (b) a local knowledge for the current architecture based on local artifacts provided by the user

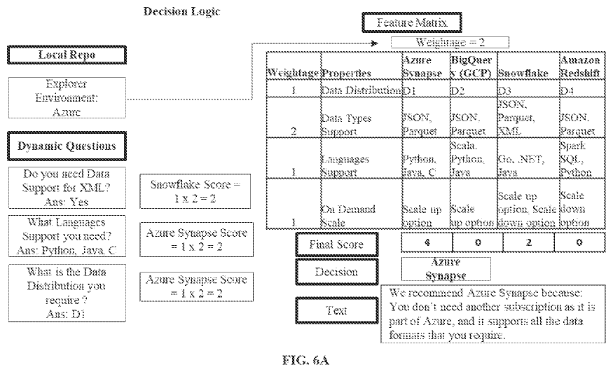

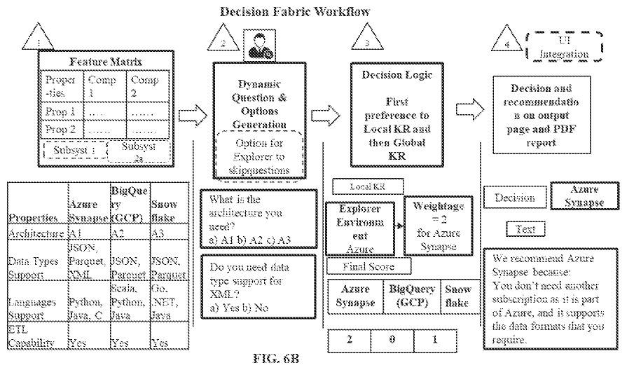

Building global knowledge repository: Based on the domain of interest, interchangeably referred to as Focus Area of the assessment, the one or more hardware processors 104 build the global knowledge repository (global KR) in the form of ‘Knowledge Graph’ by leveraging the artifacts and literature provided by the Focus Area's Subject Matter Expert. This custom-built Knowledge Graph is a knowledge base that uses a graph-structured data model or topology to integrate data. Knowledge graphs is used to store interlinked descriptions of entities—objects—with free-form semantics. In Knowledge Graph schemas, identities, and context work together to provide structure to diverse data. Schemas provide the framework for the knowledge graph, identities classify the underlying nodes appropriately, and the context determines the setting in which that knowledge exists. These components help distinguish words with multiple meanings.
1) Subject Matter Expert (SME) provides the artifacts for the Focus Area of the assessment, which are securely stored over the cloud.
2) Artifacts could be multiple formats—PDF files, text documents, weblinks, etc. The custom-built web crawler and parser can extract the relevant text from weblinks/documents and store in staging layer.
3) Advanced Natural Language Processing (NLP) based ML models ingest the text from staging layer and build the Knowledge Graph by:
   a) Tokenization of ingested text, which involves splitting the text into paragraphs and further into sentences.
   b) Pronoun identification and replacement in text. This step is one of the key feature which helps the machine to tag the pronouns to the actual Nouns, so that the entities can be identified, improving the contextual accuracy of the knowledge base.
   c) Leveraging NLP based Part of Speech model, Identification of subject, object and predicate from the sentence which eventually helps in generation of nodes and edges in the Graph. While it is possible to solve some problems starting from only the raw characters, linguistic knowledge can be applied to add relevant information.
   d) Leveraging NLP based dependency parser to identify the root of sentence and dependent words. This is the process of extracting the dependency parse of a sentence to represent its grammatical structure. It defines the dependency relationship between headwords and their dependents. This is unique approach that precisely identifies the entities for global Knowledge Graph nodes. Thus, based upon the above steps a build Knowledge Graph is built which has Node—to Node connection as depicted in FIG. 3 and explained later in conjunction with use case scenario of FIGS. 6A and 6B.

Building Local Knowledge Repository: The purpose of local knowledge repository (Local KR) is to store the information about current landscape/architecture of the stakeholder. This information can either flow in from artifacts or the initial Focus Area assessment or domain of interest user such as the organization identified. In contrast to Global KR, the Local KR has limited scope and is built for a specific stakeholder. This is because the Local KR is built using the artifacts provided by the stakeholder who is taking the assessment. Hence this repository cannot be shared outside the limited scope of the current specific stakeholder.
1) Stakeholders provide the artifacts for the Focus Area of the assessment/domain of interest, which are securely stored over the cloud with limited/restricted access. Artifacts could be multiple formats—PDF files, text documents, weblinks, etc. The custom-built web crawler & parser will extract the relevant text from weblinks/documents and store in staging layer.
2) Advanced NLP based ML model can ingest the text from staging layer and build the Knowledge Graph. Below are the steps for building Knowledge Graph
   a) Tokenization of ingested text, which involves splitting the text into paragraphs and further into sentences.
   b) Pronoun identification and replacement in text. This step is one of the key feature which helps the machine to tag the pronouns to the actual Nouns, so that the entities can be identified. This will improve the contextual accuracy of the knowledge base.
   c) Leveraging NLP based Part of Speech model, Identification of subject, object and predicate from the sentence eventually help in generation of Nodes and Edges in the Graph. While it is possible to solve some problems starting from only the raw characters, apply linguistic knowledge to add relevant information.
   d) Leveraging NLP based Dependency parser to identify the root of sentence and dependent words. This is the process of extracting the dependency parse of a sentence to represent its grammatical structure. It defines the dependency relationship between headwords and their dependents. This is a contextual design to stakeholder which is unique and novel in its nature that precisely identifies the entities for Global Knowledge Graph nodes. Based upon the above steps we will be able to build Knowledge Graph which has Node- to Node connection as shown below.

As the global and local knowledge repository is the next step is decision making, which starts with the feature matrix generation. The feature matrix is a structure to host data for comparing various elements of the domain of interest, interchangeably referred to Focus area of the assessment. Thus, at step 208 of the method 200, the one or more hardware processors 104 dynamically generate the feature matrix by extracting one or more entities from the global knowledge repository in accordance with the plurality of inputs, provided by the SME, and comprising a list of properties, a weightage of each of the list of properties and a list of components for the domain of interest, via the one or more hardware processors.

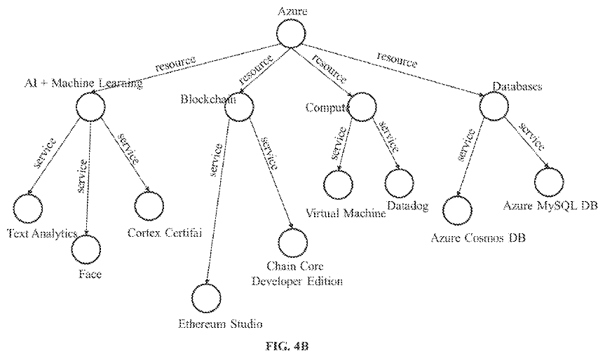

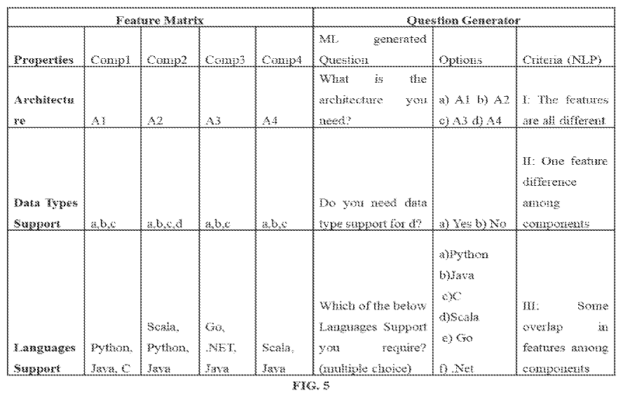

Feature matrix generation: The Feature Matrix is hosted on Graph Database where various properties associated with each node could be dynamically generated and updated. This makes the process of keeping data and data associations dynamically refreshed and stay contextually relevant with evolving technology and changing landscapes at stakeholder's environment.
1) Subject Matter Expert provides the list of Properties indicating basis of comparison, Weightages of Properties indicating relative importance, and Components indicating entities to be compared as depicted in examples of feature matrix in tabular form in FIG. 4A and FIG. 5.
2) Based upon the Property-Component combination, an advanced NLP algorithm based ML models search for relevant entities from the knowledge graph and extracts the matching text. ML based NLP techniques known in the art are used and ML models are accordingly pretrained for entity extraction.
3) This text is placed corresponding to (i) the searched property such as sentiment analysis, entity extraction and conversational ability and (ii) component such as Azure, GCP, AWS in a tabular structure of the feature matrix as depicted in FIG. 4A. The tabular structure of the feature matrix holds the relevant text corresponding to each property and component.
4) This data is then stored in graph DB as Node—property relationship architecture. FIG. 4B depicts node property relationship of another example feature matrix. All the information pertaining to single focus area (domain of interest) saved in Graph database is called feature matrix for that focus area. Thus, for plurality of domains, plurality of feature matrices will be generated and stored in the database 108 to be used for future repeated requests for similar domain. However, these already generated feature matrix can be updated based changes in the plurality of inputs provided by the SME.

The text stored corresponding to the property of each entity in the feature matrix is later utilized in dynamically generating decision questions for navigating the user through complex decision related with selection of platform, process, technology, and technical components. Thus, at step 210 of the method 200, the one or more hardware processors 104 sequentially query the user, via the decision module 110B executed by the one or more hardware processors with the set of decision questions starting with context of the initial decision node and receiving a corresponding decision response for each decision question among the set of decision questions. Each decision question has an associated decision response type, one or more choices for a decision response, dependency links of a decision question with remaining decision questions among the set of decision questions, a decision question weightage and information in an attribute value form associated with each decision response. Each successive decision question among the set of decision questions is identified based on the decision response of the user to a previous decision question. FIG. 5 depict another sample feature matrix and set of question derived from the feature matrix.

Dynamic Question Generation: As mentioned, the decision questions are generated dynamically based on the information present in the feature matrix. The answers (decision responses) to these questions help capture the preferences of the stakeholder/user and thus help in making decisions for them. The questions are generated leveraging advanced NLP techniques thus eliminating manual intervention and making the process autonomous as specified in the steps below:
a. The question generation points to the appropriate Feature Matrix in Graph db corresponding to the Focus Area of interest.
b. The process of question generation iterates over the properties present in the feature matrix.
c. For each property, the text present corresponding to all the components to be compared is extracted.
d. Based on NLP techniques known in the art the text is analyzed and mapped to one of the below criteria:
   I. There is no overlap in text (features) of the components being compared: For this specific criterion, appropriate single select type of question is generated. The user can select any one option as a referred choice.
   II. There is overlap in text (features) with only one feature being different among the components: For this criterion, yes/no type of question would be generated which specifically targets the feature that is unique among the features supported by all components.
   III. There is overlap in text (features) with multiple features being different among the components: For this criterion, multiple choice question would be generated with the user having the ability to select multiple features which the deem required for their needs.

Generating Choices and Probability Ranking for fitment to Recommend for Decision: Relevant and contextual choices are generated for selecting the decision response by trained Machine Learning (ML) models using combination of the local knowledge repository and the global knowledge repository in accordance with a plurality of features present in the feature matrix, wherein the choices are ranked according to probability of generating best possible decision, and wherein for any unanswered question, the decision response is identified by the trained ML model. The Local KR is crucial for making the options contextual to the users or the stakeholders. This ranking helps the system 100 to recommend a choice to the stakeholder who can then review and approve the choice if it matches their requirement.

### Generating Choices for Decision Responses—

a. Iterate over the properties present in the feature matrix.
b. For each property extract the text present corresponding to all the components to be compared.
c. Based on NLP techniques the text is analyzed and mapped to one of the below criteria:
   I. There is no overlap in text (features) of the components being compared: For this criterion, as all components have different features, the options generated are the features from each component with number of options being equal to number of components in the Feature Matrix. The user can select only one option and the respective component will be scored higher than others.
   II. There is overlap in text (features) with only one feature being different among the components: For this criterion, the options generated would be of type Boolean with only two values Yes and No. This is because the question would be targeting only the feature that is unique among the features supported by all components.
   III. There is overlap in text (features) with multiple features being different among the components: For this criterion, options would be generated after removal of the duplicate features supported by the components. The number of options would be equal to the number of unique features of all components. Stakeholder can select multiple options according to their requirement.

At step 212 of the method 200, the one or more hardware processors 104 generate the decision graph tracing a plurality of decision nodes starting from the initial decision node based on each decision response for each of the decision questions. At step 214 of the method 200 the one or more hardware processors 104 utilize a decision path identified from the decision graph and the information in the attribute value form associated with each decision response for providing the contextual advisory to build XaaS for the domain of interest using document templates. In the decision making and contextual advisory generation steps capture the decision responses from the dynamic decision questions and ML models enable selecting the best suitable component according to the needs of the user/stakeholder. The system 100 also considers the current landscape/architecture of the user and generates wise decisions which are more tailored towards the stakeholder. The system also generates text which provides explanation on the reason of selection of component.

Steps for generating decisions in conjunction with use case scenario depicted in FIGS. 6A and 6B:
a. Capturing the decision responses to the decision questions which represents the preference of the user.
b. As explained earlier the Local KR stores the information about current landscape/architecture of the stakeholder. This information is leveraged to allocate weightages to the components of the feature matrix. For example, if current landscape of the stakeholder is on Azure, then if any Azure components present in the Feature Matrix would be given higher weightage. First preference is given to Local KR and then to Global KR for precise decision making. This step of leveraging Local KR (Stakeholder centric information) to automate decision making for Stakeholder landscape provides more relevant and contextual decision making.
c. A scoring algorithm considers two sets of weightages namely properties weightages and component weightages.
d. Based upon the options chosen by the stakeholder/user, the scoring algorithm calculates scores for each component in the feature matrix. This is performed by complex matrix multiplication considering the weightages.
e. A final score is computed for each component and the highest scoring component is then selected as the recommended decision.
f. For producing the text to support the decision made, the system analyzes the questions where the final component has scored highest. Those questions are then converted into simple sentence using known in the art NLP techniques. Also, any consideration of the current landscape of the stakeholder is highlighted if applicable for the component.

Example Use case scenario: Let ‘Data Warehousing’ be identified as the domain of interest (focus area of assessment). First the maturity level of the stakeholder or user is assessed. After which depending on the current maturity level, the decisions are made to navigate him/her through decisions and improve the level of maturity.

### Sequence of Steps Involved:

a. SME provides the artifacts related to Data Warehousing. This can include official websites of components to be compared like Snowflake, Azure Synapse, etc. They can also provide industry standard best practices documents. For example, https://www.snowflake.com/; https://azure.microsoft.com/en-in/services/synapse-analytics/#overview
b. The global knowledge repository (Global KR) in the form of a knowledge graph, similar to the one depicted in FIG. 3, is generated based on above artifacts.
c. Creation of the local knowledge repository (Local KR) is the next step in the process. Based on the initial assessment the system 100 identifies stakeholder having enterprise level Azure subscription. This is important information which can play a role in decision making. Hence this information is saved as part of the Local KR along with similar stakeholder specific information
d. Next, to generate feature matrix, SME provides the list of Properties—Architecture, Data format support, Language support, etc., Weightages of Properties—weightage value—2 assigned to Data format support for its relative importance and Components—Azure Synapse, Bigquery, Snowflake, Amazon Redshift.
e. Based on this, the entities are extracted from Global KR, and the feature matrix is built as depicted below in table 1.

TABLE 1

| | Feature Matrix | Azure Synapse | Snowflake |
|---|---|---|---|
| P | Data Distribution | Data is sharded into | Distributed |
| | | distributions | System based |
| | | | on micro- |
| | | | partitioning & |
| | | | automatic |
| | | | clustering |
| P | Data Format | JSON, Avro, ORC, | JSON, Avro, |
| | Support | Parquet | ORC, Parquet, |
| | | | XML |
| P | Languages | Python, Scala, Java, | Go, Java, .NET, |
| | Support | Spark SQL, | Node.js, C, |
| | | and .NET | Python |
| P | On Demand Scale | Scale up option | Scale up option, |
| | | | Scale down |
| | | | option |

f. Dynamic decision questions are generated based on the feature matrix build in table 1. Few sample questions generated are as shown below.

What is the type of Data Distribution you required?
A) Data is sharded into distributions
B) Distributed System based on micro-partitioning & automatic clustering

Do you need support for XML data format?
A) Yes—ML model based recommendation by system to assist user
B) No

Which of the below Languages Support you require?
A) Python B) Java
C) NET D) Scala
E) C F) Spark SQL
g. In final step is of decision making, the system 100 process the responses of the above questions. FIGS. 6A and 6B provide pictorial representation of custom designed decision process. The automated decision making is a result of evaluation of different options and configuration of weightages involved in decision making. It is done based on the contextual scenario in terms of the long-term road map vis-a-vis leveraging services from different public cloud vendors.
h. Document model of the document generator 110C selects type of advisory documents to be generated and identifies replaceable attributes. Each advisory document is a combination of static document with marked dynamics information with attributes.
i. Replaceable attribute value is generated from information received. For example, this can be replacing tool names or selecting different diagram, selecting different section or information provided by user. If no information is received for an attribute, default values are used. E.g., in case no information received on reference architecture, default architecture diagram is used else modified reference architecture is used.
j. The document generator 110C picks up the static and dynamic component and create various types of document including .pdf, pptx which help customer or user in blueprint, reference architecture, advisory, roadmap etc. E.g., Document as attributes defined {Cloud Name}, {DevOps Tool Name} etc. This attribute value is determined based on the information received from decision nodes. This information is mapped to attribute values. Document finds and replaces attributes. In many cases entire section is added depending on the decision e.g., multi-tenancy section is inserted depending on the selected multi-tenancy model.

The method 200 enables identifying dependency to consider impact of particular solution for one attribute on solution choice for another attribute. Example 1 and 2 below depicts how decisions are generated based on decision questions and dependency between them.

### Example 1: Assessment for Deep Learning Frameworks (Initial User Inclination), Wherein Text in Bold Indicates User Choice

1. Do you plan to utilize Big Data for AIML use cases?
Yes No
2. Do you need your Deep learning framework to be Cloud compatible?
Yes No
3. Are you only looking for open-source Deep learning frameworks?
Yes No
4. What are the primary use cases you plan to use Deep learning for in your organization?

| Vision | Speech |
|---|---|
| Text | Structured |
| | Data |

5. For the Interface, which is your preferred language?

Python
Java

Output Recommendation (contextual advisory):

Caffe: As Caffe framework benefits from having a large repository of pre-trained neural network models suited for a variety of image classification tasks. It is also compatible with Cloud platforms and Big Data.

### Example 2: Assessment for Deep Learning Frameworks (Initial User Inclination), Wherein Text in Bold Indicates User Choice

1. Do you plan to utilize Big Data for AIML use cases?
Yes No
2. Do you need your Deep learning framework to be Cloud compatible?
Yes No
3. Are you only looking for open-source Deep learning frameworks?
Yes No
4. What are the primary use cases you plan to use Deep learning for in your organization?

| Vision | Speech |
|---|---|
| Text | Structured |
| | data |

5. For the Interface, which is your preferred language?
   Python
   Java

Output Recommendation (contextual advisory):

Deeplearning4j—As Deeplearning4j is a popular deep learning framework that is focused on Java technology. It also supports AIML use case for structured data.

Unlike the static method of decision making in conventional approaches when an enterprise decides to move to subscription-based models or XaaS, the method and system disclosed herein enables dynamic, automated, and intuitive decision making from a more contextual and dependency-aware range of attributes. The system enables to layout the range or breadth of components and attributes that are required for SaaSification, so that through the automated and intuitive process of dynamic decision making disclosed, the system generate a unique and a highly contextual advisory. This invention takes users initial assessment input and decision choices and translate this information into intelligent decisions, providing an approach to map SaaS platform and product engineering decisions through node-based dependency graphs, wherein selected nodes are then used to create the dynamic advisory output. Based on hypothesis that the data is correctly collected and analyzed, the solution reduce 6 months efforts to 2 months for the enterprises providing speedy, customized XaaS transformation solution

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for generating a contextual advisory for Everything as a service (XaaS), the method comprising:
obtaining, via one or more hardware processors, a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions,
wherein each successive question among the set of questions is identified based on the response of the user to a previous question and is mapped to an initial inference node among a plurality of inference nodes preset in an inference table,
wherein each inference node corresponds to a set of inferences with each inference among the set of inferences having an initial inference weightage,
wherein the initial inference node and the initial inference weightage of each inference node is iteratively updated in accordance with the response of the user to each question, and
wherein each inference node among the set of interference nodes is mapped to a decision node from among a plurality of decision nodes;
identifying, via the one or more hardware processors, a final inference node and a corresponding decision node among the plurality of decision nodes as an initial decision node, post querying the user with the set of questions, wherein the final interference node indicates initial user inclination and a current architecture of the user in the domain of interest;
generating in the form of knowledge graph (a) a global knowledge repository for the domain of interest based on artifacts provided by a Subject Matter Expert (SME), and (b) a local knowledge repository for the current architecture based on artifacts provided by the user, via the one or more hardware processors;
generating a feature matrix, by extracting one or more entities from the global knowledge repository in accordance with a plurality of inputs, provided by the SME, and comprising a list of properties, a weightage of each of the list of properties and a list of components for the domain of interest, via the one or more hardware processors;
sequentially querying the user, via the one or more hardware processors, with a set of decision questions starting with context of the initial decision node and receiving a corresponding decision response for each decision question among the set of decision questions, wherein each decision question has an associated decision response type, one or more choices for a decision response, dependency links of a decision question with remaining decision questions among the set of decision questions, a decision question weightage and information in an attribute value form associated with each decision response, wherein each successive decision question among the set of decision questions is identified based on the decision response of the user to a previous decision question;
generating, via the one or more hardware processors, a decision graph tracing a plurality of decision nodes starting from the initial decision node based on each decision response for each of the decision questions; and
utilizing, via the one or more hardware processors, a decision path identified from the decision graph and the information in the attribute value form associated with each decision response for providing the contextual advisory to build XaaS for the domain of interest using document templates.

2. The method of claim 1, wherein relevant and contextual choices are generated for the decision response by trained Machine Learning (ML) models using combination of the local knowledge repository and the global knowledge repository in accordance with a plurality of features present in the feature matrix, wherein the choices are ranked according to probability of generating best possible decision, and wherein for any unanswered question, the decision response is identified by the trained ML model.

3. The method of claim 1, wherein the contextual advisory comprises roadmap, blueprint, reference architecture and miscellaneous advisory documents, wherein the contextual advisory is a combination of static document with marked dynamics sections populated based on the decision path of the user.

4. The method of claim 1, wherein, the feature matrix is a structure to host data on a graph database for comparing the one or more entities and associated information obtained from the global knowledge repository across the plurality of inputs.

5. The method of claim 1, wherein each question among the set of questions has an associated response type, one or more choices for a response, dependency links of a question with remaining questions among the set of questions, and a question weightage.

6. A system for generating a contextual advisory for Everything as a service (XaaS), the system comprising:
a memory storing instructions;
one or more Input/Output (I/O) interfaces; and
one or more hardware processors coupled to the memory via the one or more I/O interfaces, wherein the one or more hardware processors are configured by the instructions to:
obtain a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions,
wherein each successive question among the set of questions is identified based on the response of the user to a previous question and is mapped to an initial inference node among a plurality of inference nodes preset in an inference table,
wherein each inference node corresponds to a set of inferences with each inference among the set of inferences having an initial inference weightage,
wherein the initial inference node and the initial inference weightage of each inference node is iteratively updated in accordance with the response of the user to each question, and
wherein each inference node among the set of interference nodes is mapped to a decision node from among a plurality of decision nodes;
identify a final inference node and a corresponding decision node among the plurality of decision nodes as an initial decision node, post querying the user with the set of questions, wherein the final interference node indicates initial user inclination and a current architecture of the user in the domain of interest;
generate in the form of knowledge graph (a) a global knowledge repository for the domain of interest based on artifacts provided by a Subject Matter Expert (SME), and (b) a local knowledge repository for the current architecture based on artifacts provided by the user;
generate a feature matrix, by extracting one or more entities from the global knowledge repository in accordance with a plurality of inputs, provided by the SME, and comprising a list of properties, a weightage of each of the list of properties and a list of components for the domain of interest;
sequentially query with a set of decision questions starting with context of the initial decision node and receiving a corresponding decision response for each decision question among the set of decision questions, wherein each decision question has an associated decision response type, one or more choices for a decision response, dependency links of a decision question with remaining decision questions among the set of decision questions, a decision question weightage and information in an attribute value form associated with each decision response, wherein each successive decision question among the set of decision questions is identified based on the decision response of the user to a previous decision question;
generate a decision graph tracing a plurality of decision nodes starting from the initial decision node based on each decision response for each of the decision questions; and
utilize a decision path identified from the decision graph and the information in the attribute value form associated with each decision response for providing the contextual advisory to build XaaS for the domain of interest using document templates.

7. The system of claim 6, wherein the one or more hardware processors are configured to generate relevant and contextual choices for the decision response by trained Machine Learning (ML) models using combination of the local knowledge repository and the global knowledge repository in accordance with a plurality of features present in the feature matrix, wherein the choices are ranked according to probability of generating best possible decision, and wherein for any unanswered question, the decision response is identified by the trained ML model.

8. The system of claim 6, wherein the contextual advisory comprises roadmap, blueprint, reference architecture and miscellaneous advisory documents, wherein the contextual advisory is a combination of static document with marked dynamics sections populated based on the decision path of the user.

9. The system of claim 6, wherein, the feature matrix is a structure to host data on a graph database for comparing the one or more entities and associated information obtained from the global knowledge repository across the plurality of inputs.

10. The system of claim 6, wherein each question among the set of questions has an associated response type, one or more choices for a response, dependency links of a question with remaining questions among the set of questions, and a question weightage.

11. One or more non-transitory machine-readable information storage mediums comprising one or more instructions which when executed by one or more hardware processors cause:
obtaining, a domain of interest and an initial inclination of a user indicating maturity of the user in the domain of interest when user requests for the contextual advisory for a platform, a process, a technology, and technical components to build XaaS for the domain of interest, wherein the initial inclination is obtained by sequentially querying the user with a set of questions and receiving a corresponding response for each question among the set of questions,
wherein each successive question among the set of questions is identified based on the response of the user to a previous question and is mapped to an initial inference node among a plurality of inference nodes preset in an inference table,
wherein each inference node corresponds to a set of inferences with each inference among the set of inferences having an initial inference weightage,
wherein the initial inference node and the initial inference weightage of each inference node is iteratively updated in accordance with the response of the user to each question, and
wherein each inference node among the set of interference nodes is mapped to a decision node from among a plurality of decision nodes;
identifying a final inference node and a corresponding decision node among the plurality of decision nodes as an initial decision node, post querying the user with the set of questions, wherein the final interference node indicates initial user inclination and a current architecture of the user in the domain of interest;
generating in the form of knowledge graph (a) a global knowledge repository for the domain of interest based on artifacts provided by a Subject Matter Expert (SME), and (b) a local knowledge repository for the current architecture based on artifacts provided by the user;
generating a feature matrix, by extracting one or more entities from the global knowledge repository in accordance with a plurality of inputs, provided by the SME, and further comprising a list of properties, a weightage of each of the list of properties and a list of components for the domain of interest;
sequentially querying the user with a set of decision questions starting with context of the initial decision node and receiving a corresponding decision response for each decision question among the set of decision questions, wherein each decision question has an associated decision response type, one or more choices for a decision response, dependency links of a decision question with remaining decision questions among the set of decision questions, a decision question weightage and information in an attribute value form associated with each decision response, wherein each successive decision question among the set of decision questions is identified based on the decision response of the user to a previous decision question;
generating a decision graph tracing a plurality of decision nodes starting from the initial decision node based on each decision response for each of the decision questions; and
utilizing a decision path identified from the decision graph and the information in the attribute value form associated with each decision response for providing the contextual advisory to build XaaS for the domain of interest using document templates.

12. The one or more non-transitory machine-readable information storage mediums of claim 11, wherein relevant and contextual choices are generated for the decision response by trained Machine Learning (ML) models using combination of the local knowledge repository and the global knowledge repository in accordance with a plurality of features present in the feature matrix, wherein the choices are ranked according to probability of generating best possible decision, and wherein for any unanswered question, the decision response is identified by the trained ML model.

13. The one or more non-transitory machine-readable information storage mediums of claim 11, wherein the contextual advisory comprises roadmap, blueprint, reference architecture and miscellaneous advisory documents, wherein the contextual advisory is a combination of static document with marked dynamics sections populated based on the decision path of the user.

14. The one or more non-transitory machine-readable information storage mediums of claim 11, wherein, the feature matrix is a structure to host data on a graph database for comparing the one or more entities and associated information obtained from the global knowledge repository across the plurality of inputs.

15. The one or more non-transitory machine-readable information storage mediums of claim 11, wherein each question among the set of questions has an associated response type, one or more choices for a response, dependency links of a question with remaining questions among the set of questions, and a question weightage.
